(19) United States
(12) Patent Application Publication
(10) Pub. No.: US 2014/0320249 A1
(43) Pub. Date: Oct. 30, 2014

(54) REACTOR

(71) Applicants: Mao NOBUSAKA, Obu-shi (JP); Takashi ATSUMI, Okazaki-shi (JP)

(72) Inventors: Mao NOBUSAKA, Obu-shi (JP); Takashi ATSUMI, Okazaki-shi (JP)

(73) Assignee: TOYOTA JIDOSHA KABUSHIKI KAISHA, Toyota-shi (JP)

(21) Appl. No.: 14/257,311

(22) Filed: Apr. 21, 2014

(30) Foreign Application Priority Data
Apr. 26, 2013 (JP) 2013-093241

(51) Int. Cl. H01F 27/02; H01F 27/28

(52) U.S. Cl. CPC H01F 27/02; H01F 27/28
USPC 336/90

(57) ABSTRACT

A reactor that can be disposed between stacked coolers, the reactor includes a flat case, a pair of coils, and core material. The pair of coils is (i) located in the flat case, (ii) wound in opposite directions from each other, and (iii) disposed adjacent to each other in a radial direction of the coils. The core material is covering the coils in the flat case.

### INCORPORATION BY REFERENCE

The disclosure of Japanese Patent Application No. 2013-093241 filed on Apr. 26, 2013 including the specification, drawings and abstract is incorporated herein by reference in its entirety.

### BACKGROUND OF THE INVENTION

1. Field of the Invention

The present invention relates to a reactor that includes a coil.

2. Description of Related Art

A power converter that converts output power of a battery to suitable power for driving a traveling motor is mounted in an electric vehicle such as a hybrid electric vehicle. Because this electric converter handles a large current, devices with a large allowable current are adopted for use in an inverter circuit and a voltage converter circuit. The devices with the large allowable current generate a large amount of heat, and one of the devices that generate the particularly large amount of heat is a reactor included in the voltage converter circuit.

As for a reactor, a technique disclosed in Japanese Patent Application Publication No. 2001-244123 (JP 2001-244123 A) has been known, for example. JP 2001-244123 A discloses a reactor of surface-mounted type that is formed of upper and lower ferrite magnetic films and a flat coil interposed therebetween. An opening is formed in a portion of the upper ferrite magnetic film that corresponds to a terminal of the coil, and an external electrode that passes through the opening and is conducted with the terminal of the coil is formed on an upper ferrite.

### SUMMARY OF THE INVENTION

A reactor used for a power converter tends to be large in size as it handles a large current. Meanwhile, downsizing of such a reactor has been demanded for installation in a hybrid electric vehicle and the like. In addition, due to a large amount of heat generation, a structure capable of facilitating cooling and an increase in inductance have been demanded. Accordingly, a technique disclosed herein provides a reactor that can increase inductance, is small in size, and can easily be cooled.

A first aspect of the present invention is a reactor that can be disposed between stacked coolers. The reactor includes a flat case, a pair of coils and core material. The pair of coils is (i) located in the flat case, (ii) wound in opposite directions from each other, and (iii) disposed adjacent to each other in a radial direction of the coils. The core material is covering the coils in the flat case.

According to such a configuration, magnetic fluxes opposing each other are generated in the pair of coils when a current flows through the coils. Then, the opposing magnetic fluxes are joined to each other to generate a large magnetic flux. This can increase the inductance of the reactor. In addition, the flat case can secure a contact area with each of the coolers despite the small size thereof. Therefore, it is possible to provide a reactor that can increase the inductance, is small in size, and can easily be cooled.

In the above reactor, the coils of the pair of coils may be aligned in a direction intersecting an axial direction of winding of the coils.

In the above reactor, the core material may include a high-permeability core material and a low-permeability core material. The high-permeability core material may cover first portions of each of the pair of coils. The low-permeability core material may cover the high-permeability core material and second portions of each of the pair of coils not covered by the high-permeability core material. Here, the “core material” refers to a substance used as a core of the coil, the “high permeability” and the “low permeability” are relative expressions in general, and the high-permeability core material is formed of a material having the higher permeability than the low-permeability core material.

According to the configuration just as described, because the large magnetic flux generated in the pair of coils passes through the high-permeability core material with the high permeability, it is possible to suppress leakage of the magnetic flux in adjacent portions of the pair of coils. Accordingly, it is possible to suppress generation of eddy current around the reactor that is caused by the leakage of the magnetic flux and thus possible to suppress eddy current loss. In addition, the low-permeability core material is disposed around the high-permeability core material. Thus, even when the high-permeability core material is magnetically saturated, the magnetic flux passes through the low-permeability core material therearound, and it is possible to prevent the magnetic saturation of the core materials as a whole in the flat case.

In the above-described reactor, the pair of coils may include a first coil and a second coil. The first portions of the first and second coils face each other and may be covered by the high-permeability core material, and the second portions of the first and second coils may not face each other and may not covered by the high-permeability core material.

In the above-described reactor, outer peripheries of the coils of the pair of coils in the radial direction may contact each other. According to such a configuration, because the adjacent portions of the pair of coils contact each other and the coils can be disposed in a tightly fitted manner in the flat case, it is possible to downsize the flat case. Therefore, it is possible to downsize the reactor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view of a reactor according to an embodiment;

FIG. 2 is a cross-sectional view taken along the line II-II of FIG. 1;

FIG. 3 is a cross-sectional view taken along the line III-III of FIG. 2;

FIG. 4 is a graph for describing materials for a high-permeability core material and a low-permeability core material;

FIG. 5 is a perspective view of a power converter that includes the reactor;

FIG. 6 is a cross-sectional view of the reactor according to another embodiment;

FIG. 7 is a perspective view of the reactor according to further another embodiment;

FIG. 8 is a cross-sectional view taken along the line VIII-VIII of FIG. 7; and

FIG. 9 is a cross-sectional view of the reactor according to yet another embodiment.

### DETAILED DESCRIPTION OF EMBODIMENTS

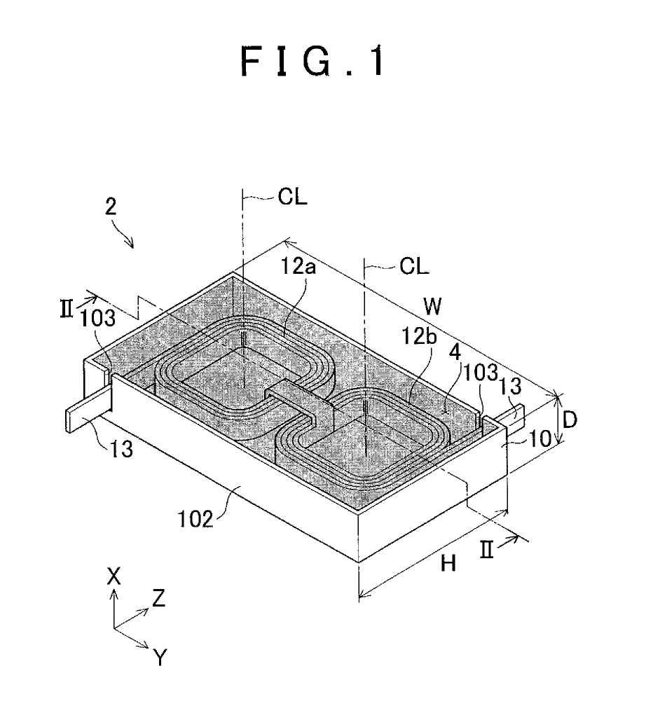

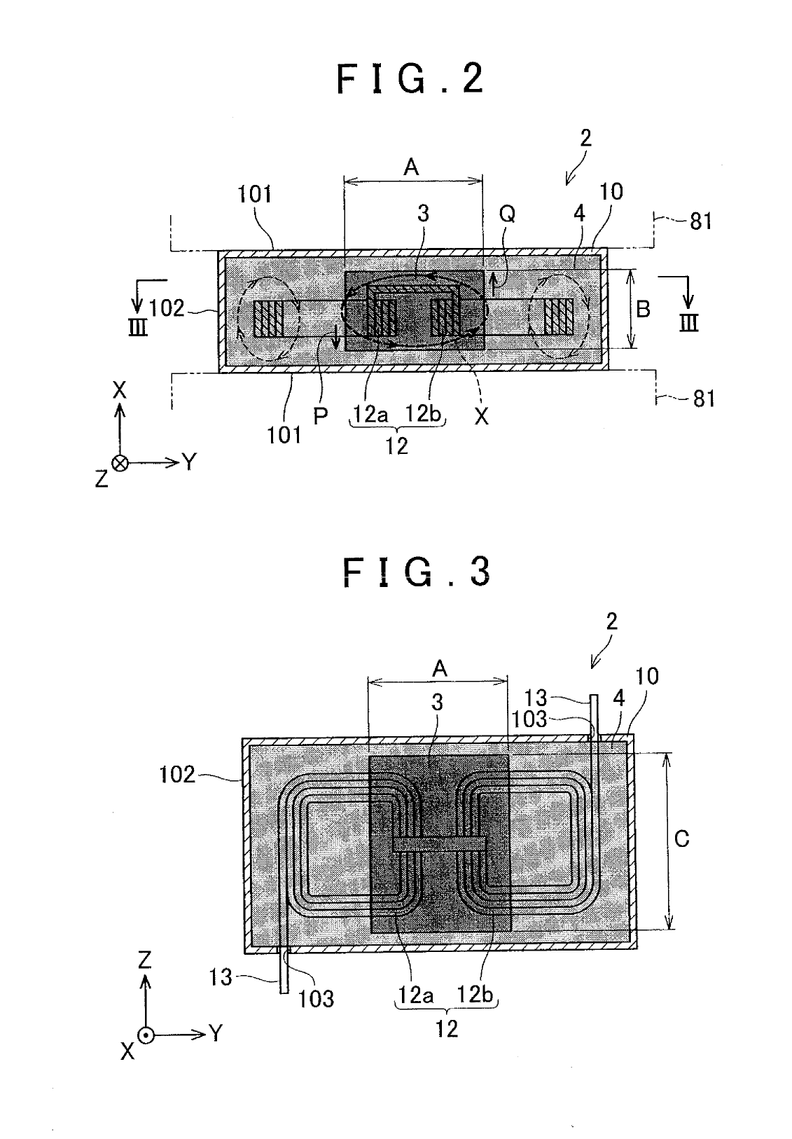

A description will hereinafter be made on embodiments with reference to the accompanying drawings. FIG. 1 is a perspective view of a reactor according to an embodiment. FIG. 2 is a cross-sectional view taken along the line II-II of FIG. 1, and FIG. 3 is a cross-sectional view taken along the line III-III of FIG. 2. In FIG. 1, a part of a case (flat case) 10 is opened so that a configuration of a reactor 2 can easily be seen. The reactor 2 is disposed between stacked coolers 81, which will be described below. As shown in FIG. 1 to FIG. 3, the reactor 2 includes the case 10 and a pair of coils 12 (a first coil 12a and a second coil 12b) that are disposed in the case 10. The case 10 is of flat shape. The reactor 2 also includes core materials (a high-permeability core material 3 and a low-permeability core material 4) filled in the case 10. The high-permeability core material 3 is not seen in FIG. 1 because it is covered by the low-permeability core material 4. The coils 12 are actually invisible as being covered by the low-permeability core material 4; however, they are shown by solid lines in FIG. 1 to FIG. 3 to facilitate understanding. In FIG. 2, a part of the stacked cooler 81 is shown by a phantom line.

The case 10 includes upper and lower cooling surfaces 101 and a side surface 102 that is fixed to peripheries of the cooling surfaces 101, and each of the cooling surfaces 101 is disposed to face the cooler 81. The cooling surface 101 and the side surface 102 are orthogonal to each other, the cooling surface 101 faces in a stacked direction of the cooler 81, and the side surface 102 extends along the stacked direction. The paired coils 12 are aligned with a space therebetween in the case 10. For purposes of reducing a stacking height and increasing a cooling area, the case 10 is formed to be flat, and an area (height) of the side surface 102 is relatively smaller to an area of the cooling surface 101. The case 10 as a whole has a substantially rectangular parallelepiped shape with a height H, a width W, and a depth D. These dimensions have a relationship of the width W>the height H>the depth D. An X-direction of coordinate axes corresponds to the stacked direction of the reactor 2 and the cooler 81. Accordingly, the case 10 is a flat body in which the depth D in the stacked direction (the height of the side surface 102) has a smaller value than the height H and the width W of the cooling surface 101 that faces in the stacked direction. Due to its flat body, the case 10 can secure a large contact area with the cooler 81. Accordingly, this achieves superior heat transfer efficiency to the coolers 81 that are disposed on both sides in the stacked direction. In addition, a slit 103 is formed at an end of the case 10.

Each of the coils 12 (the first coil 12a and the second coil 12b) is formed by winding a rectangular wire 13 that is made of a metal such as copper flatwise, and the wound rectangular wire 13 is wound tightly and is stacked in a tightly fitted manner in a radial direction. Winding flatwise refers to a configuration in which the rectangular wire 13 is wound such that a flat surface of the wire 13 is stacked in the radial direction of the coil 12. An end of the rectangular wire 13 passes through the slit 103 of the case 10, extends to the outside, and is connected to an unillustrated power source.

In FIG. 1, CL represents axial direction of the paired coils 12. The paired coils 12 are disposed adjacent to each other in the radial direction, and are also disposed such that axial directions CL extend in parallel with each other. In other words, the paired coils 12 are aligned in a direction intersecting the axial direction CL and are disposed such that outer peripheries of the paired coils 12 in the radial direction face each other. In addition, the paired coils 12 are disposed with a space therebetween, and the flat surfaces of outermost peripheries of the rectangular wires 13 face each other. The first coil 12a and the second coil 12b that are adjacent to each other are preferably in proximity to each other. Furthermore, each of the coils 12 is disposed such that upper and lower end surfaces thereof face the cooling surfaces 101 of the case 10 and that the axial direction CL faces in the depth direction of the case 10. In other words, each of the coils 12 is disposed such that the axial direction CL thereof faces in the stacked direction of the reactor 2 and the cooler 81 (the X-direction in the drawings).

The paired coils 12 are disposed such that winding directions of the rectangular wires 13 oppose each other. In an example shown in FIG. 3, the winding direction of the one coil 12 (the first coil 12a) is clockwise while the winding direction of the other coil 12 (the second coil 12b) is counterclockwise. In other words, the first coil 12a and the second coil 12b are wound in an opposite direction from each other. Accordingly, it is configured that, when a current flows through the paired coils 12, magnetic flux directions oppose each other. In an example shown in FIG. 2, the direction of the magnetic flux generated in the first coil 12a corresponds to an arrow P direction while the direction of the magnetic flux generated in the second coil 12b corresponds to an arrow Q direction that is opposite from the arrow P. In other words, the directions of the magnetic fluxes generated in the paired coils 12 oppose each other. The paired coils 12 are connected in series, and the rectangular wires 13 of the first coil 12a and the second coil 12b are connected in adjacent portions.

An area around the coil 12 is filled with a core material (the high-permeability core material 3 or the low-permeability core material 4), and an area around the core material is surrounded by the case 10. The core material is filled in a space between the paired coils 12 and the case 10 and in a space between the first coil 12a and the second coil 12b.

The high-permeability core material 3 is uniformly filled in a center portion of the case 10 to cover the adjacent portions of the first coil 12a and the second coil 12b. More specifically, the high-permeability core material 3 covers portions of the paired coils 12 that face each other (the adjacent portions). Thus, portions of the paired coils 12 that do not face each other are exposed from the high-permeability core material 3. Although a lateral width A of the high-permeability core material 3 that is filled in the case 10 is not particularly limited, it is preferred that the lateral width A is at least wide enough to cover inner peripheral surfaces of the paired coils 12 in the sides that face each other (inner peripheries of the rectangular wires 13). In this embodiment, the high-permeability core material 3 covers a half portion of the each coil 12, and the half portion of each of the adjacent coils 12 that face each other is sealed by the high-permeability core material 3. In addition, although a depth B of the high-permeability core material 3 is not particularly limited, it is preferred that the depth B is at least high enough to cover the upper end and the lower end of the coil 12 in a thickness direction of the coils 12. In this embodiment, the high-permeability core material 3 is filled to above and below the upper end and the lower end of the coil 12 in the thickness direction of the coils 12, so as to cover the each coil 12. Furthermore, although a vertical width (a height) C of the high-permeability core material 3 is not particularly limited, it is preferred that the height C is at least wide enough to cover the outer periphery of the coil 12 in the radial direction (the outermost periphery of the rectangular wire 13). The permeability of the high-permeability core material 3 is higher than the permeability of the low-permeability core material 4 and can be set to 100 H/m or higher, for example. Meanwhile, the low-permeability core material 4 is filled in an area between the high-permeability core material 3 and the case 10.

The low-permeability core material 4 is filled in the entire area from the center portion to the end of the case 10, covers the entire high-permeability core material 3, and also covers portions of the paired coils 12 that do not face each other. In other words, the low-permeability core material 4 is uniformly filled in the area around the high-permeability core material 3 and covers the high-permeability core material 3 and the portions of the coils 12 that are exposed from the high-permeability core material 3. The permeability of the low-permeability core material 4 is lower than the permeability of the high-permeability core material 3 and can be set to 10 H/m to 20 H/m, for example. The permeability of the high-permeability core material 3 and that of the low-permeability core material 4 can be measured by using a known permeability measuring device.

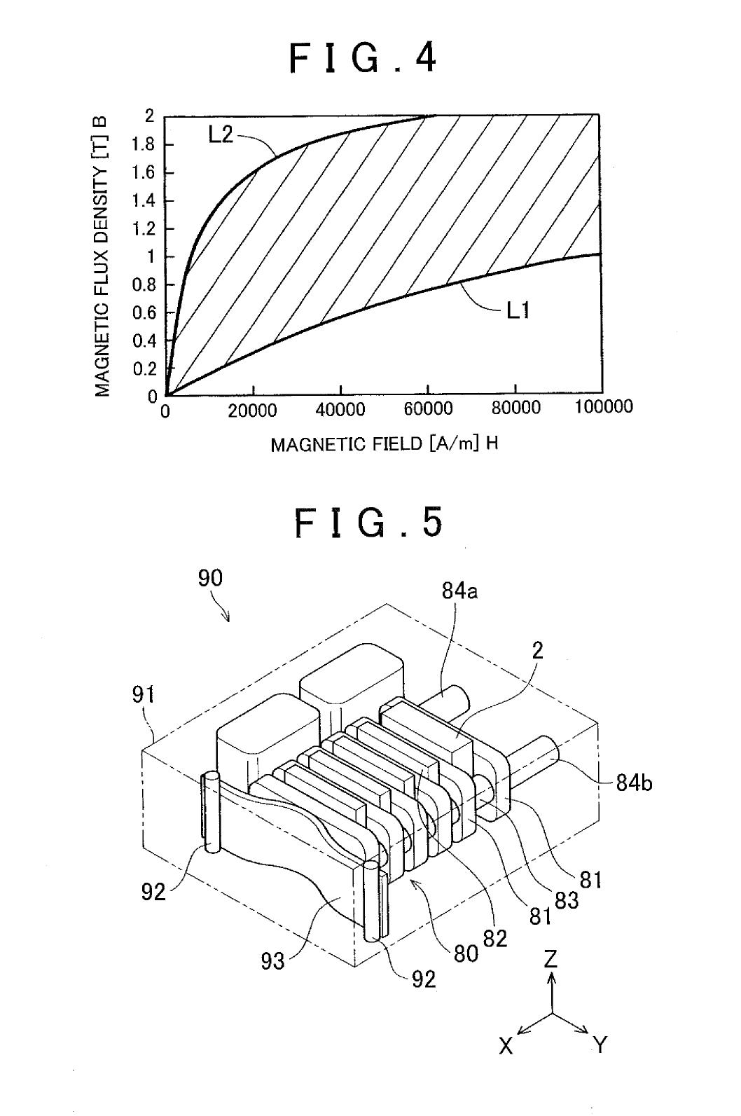

The high-permeability core material 3 and the low-permeability core material 4 can each be formed of a mixture of a resin and a magnetic material. As a resin, a thermosetting resin such as an epoxy resin or phenolic resin, for example, can be used. As a magnetic material, a ferrite powder, an iron powder, a silicon alloy iron powder, or the like can be used, for example, and Fe-6.5 Si can preferably be used. As a material for the high-permeability core material 3 and the low-permeability core material 4, a material with relative permeability of 10 to 50 can be used. The relative permeability is a ratio of the permeability of the core materials to vacuum permeability. More specifically, as a material for the high-permeability core material 3 and the low-permeability core material 4, when a graph of a magnetic field H (A/H) with magnetic flux density B (T) is plotted as shown in FIG. 4, a material that falls in a region indicated by diagonal lines between an H-B curve L1 of a material in which the resin is mixed with Fe-6.5 Si and an H-B curve L2 of a pressed powder material of Fe-3 Si can be used. Each of inclinations in the graph of FIG. 4 corresponds to the permeability.

The high-permeability core material 3 and the low-permeability core material 4 can be formed by two-color molding. In other words, the high-permeability core material 3 is injection-molded in the adjacent portions of the paired coils 12, and then the low-permeability core material 4 is injection-molded around the high-permeability core material 3.

As shown in FIG. 2 and FIG. 3, a portion of the high-permeability core material 3 that covers the first coil 12a and a portion thereof that covers the second coil 12b are connected to each other in an area between the paired coils 12a, 12b. More specifically, the portion of the high-permeability core material 3 that covers the first coil 12a and the portion thereof that covers the second coil 12b are continuous in one end side of the paired coils 12a, 12b and are also continuous in another end side thereof. In this embodiment, the high-permeability core material 3 forms one block, and the adjacent portions of the paired coils 12a, 12b are embedded in the one block. From a viewpoint of a magnetic path, the high-permeability core material 3 covers the adjacent portions of the paired coils 12 such that an annular magnetic path that passes through the each coil is formed in each of the paired coils 12 that have the parallel axes and are aligned in the radial direction of the wires. The low-permeability core material 4 covers the high-permeability core material 3, further covers the coils 12, and is filled inside the coils 12. In other words, the low-permeability core material 4 is filled in portions of the coils 12 that are not filled with the high-permeability core material 3. According to the configuration as described above, when the current flows through the paired coils 12, the magnetic flux in the arrow P direction is generated in the first coil 12a, and reversely, the magnetic flux in the arrow Q direction is generated in the second coil 12b as shown in FIG. 2. Then, the magnetic flux of the first coil 12a and that of the second coil 12b are joined to generate a large magnetic flux F in the adjacent portions of the paired coils 12, and the large magnetic flux F flows through the high-permeability core material 3 with the high permeability. Meanwhile, the magnetic flux generated in the portion exposed from the high-permeability core material 3 flows through the low-permeability core material 4.

Next, an example of a power converter to which the above reactor is applied will be described. FIG. 5 is a perspective view of the power converter including the reactor. A power converter 90 is mounted in a hybrid electric vehicle or an electric vehicle to boost DC power of a battery and to convert the DC power to AC power with a frequency suitable for driving an induction motor or a PM motor. In other words, the power converter 90 includes a boosting converter circuit and an inverter circuit. A plurality of so-called power semiconductor elements is used in each of the circuits. The plural power semiconductor elements are housed in plural semiconductor modules 82 of flat plate type. The semiconductor module 82 is formed by molding one or several of the power semiconductor elements with a resin. In FIG. 5, a terminal that extends from the semiconductor module 82 is not shown. The power semiconductor element generates a large amount of heat. Accordingly, in the power converter 90, the plural semiconductor modules 82 of the flat plate type and the plural coolers 81 of the flat plate type are stacked alternately. A stacked body formed of the plural semiconductor modules 82 and the plural cooler 81 is referred to as a stacked unit 80. In addition to the semiconductor modules 82, the reactor 2 is also stacked in the stacked unit 80. More specifically, the reactor 2 is held between the coolers 81. The reactor 2 is one of components of a boost converter. Because a circuit of the boost converter is well known, a description thereof will not be made.

In the stacked unit 80, the adjacent coolers 81 are connected by connecting pipes 83. In addition, a refrigerant supply pipe 84a and a refrigerant discharging pipe 84b are connected to the cooler 81 at an end of the stacked unit 80. The cooler 81 is a flow path through which a refrigerant flows, and the refrigerant supplied from the refrigerant supply pipe 84a spreads to all the coolers 81 through the connecting pipe 83. The refrigerant cools the adjacent semiconductor module 82 or the reactor 2 while flowing through the flow path in the cooler 81. After absorbing the heat of the semiconductor module 82 or the reactor 2, the refrigerant is discharged to the outside through the other connecting pipe 83 and the refrigerant discharging pipe 84b.

In order to increase cooling efficiency, the stacked unit 80 is pressurized in the stacked direction. The stacked unit 80 is accommodated in a housing 91, one end thereof is pressed against an inner wall of the housing 91, and a plate spring 93 is inserted on the other end side. The plate spring 93 is supported by struts 92 of the housing 91. In the housing of the power converter 90, the stacked unit 80 receives pressure in the stacked direction from the plate spring 93. When pressurized in the stacked direction, the stacked unit 80 increases the adhesion between the semiconductor module 82 and the cooler 81 and the adhesion between the reactor 2 and the cooler 81, thereby improving the heat transfer efficiency to the cooler 81.

A description will now be described on advantages of the reactor 2 that is configured as above. According to the reactor 2 of this embodiment, because the magnetic flux directions of the paired coils 12 oppose each other, it is possible by joining the magnetic flux of the each coil 12 to generate the further large magnetic flux F. Accordingly, it is possible to increase the inductance of the reactor 2. In addition, the flat case 10 can secure the contact area with the cooler 81 despite the small size thereof. Therefore, it is possible to provide the reactor 2 that can increase the inductance, is small in size, and can easily be cooled.

Furthermore, in the case 10, the area (height) of the side surface 102 is relatively smaller to the area of the cooling surface 101; therefore, the depth D is reduced, and the magnetic flux is likely to be leaked to the outside of the case 10. Particularly, because the large magnetic flux X is generated in the adjacent portions of the paired coils 12, the magnetic flux is more likely to be leaked to the outside. In consideration of this, according to the above-described configuration, the high-permeability core material 3 that covers the adjacent portions of the paired coils 12 and the low-permeability core material 4 that covers the area around the high-permeability core material 3 are provided, and the large magnetic flux X that is generated in the paired coils 12 flows through the high-permeability core material 3 with the high permeability. Thus, it is possible to suppress leakage of the magnetic flux in the adjacent portions of the paired coils 12. Therefore, it is possible to suppress generation of eddy current around the reactor 2 that is caused by the leakage of the magnetic flux and thus is possible to suppress eddy current loss. In other words, if the high-permeability core material 3 with the high permeability is not provided, the generated large magnetic flux F may be leaked in an area around the reactor 2, and the eddy current may thereby be generated in the cooler 81 and the like around the reactor 2, for example. On the contrary, according to this embodiment, it is possible to suppress the leakage of the magnetic flux and is also possible to suppress the eddy current loss. Moreover, the low-permeability core material 4 is disposed around the high-permeability core material 3. Accordingly, even when the high-permeability core material 3 is magnetically saturated, the magnetic flux passes through the low-permeability core material 4 therearound, and thus the low-permeability core material 4 serves as a backup. Therefore, it is possible to prevent the magnetic saturation of the core materials as a whole in the case 10.

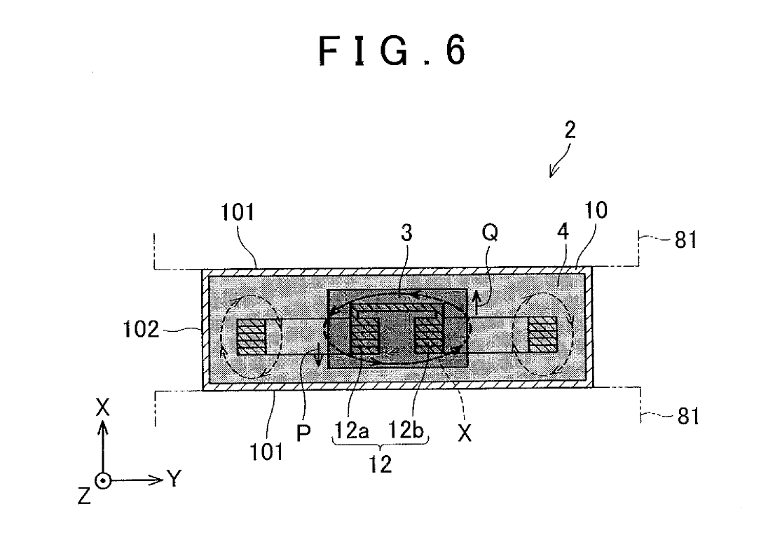

The description has been made so far on the one embodiment. However, the specific mode is not limited to the above embodiment. For example, although the coil 12 is formed by winding the rectangular wire 13 flatwise in the above embodiment, the coil 12 may be formed by winding the rectangular wire 13 edgewise as shown in FIG. 6. Winding edgewise refers to a configuration in which the flat surface of the rectangular wire 13 is wound to be stacked in the axial direction of the coil 12, and the stacked direction of the rectangular wire 13 follows the axial direction of the coil 12.

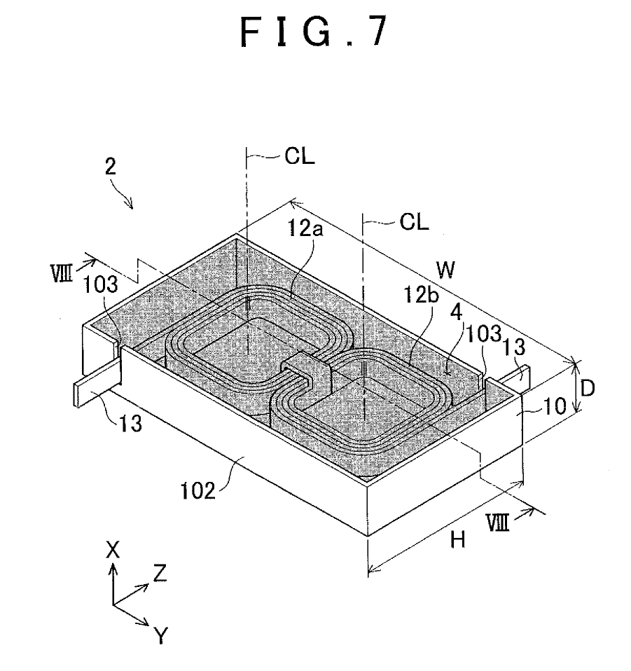

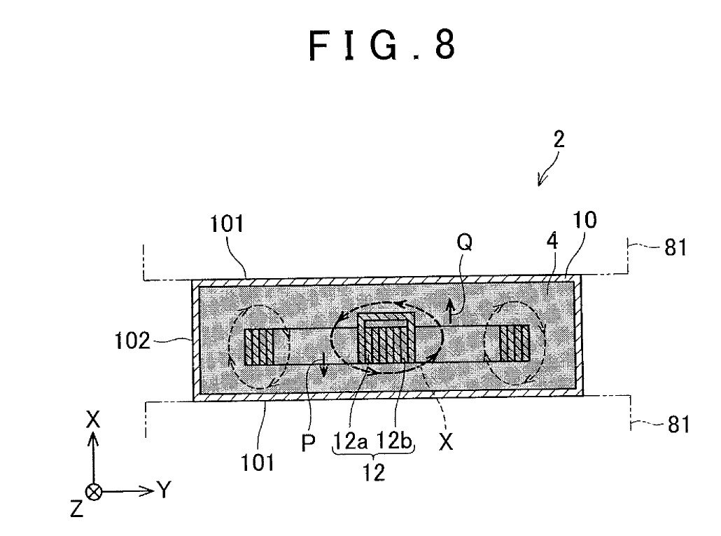

FIG. 7 is a perspective view of the reactor according to yet another embodiment, and FIG. 8 is a cross-sectional view taken along the line VIII-VIII of FIG. 7. In FIG. 7 and FIG. 8, the same components as those in FIG. 1 and FIG. 2 are denoted by the same reference numerals, and the description thereof will not be repeated. In the above-described embodiment, the first coil 12a and the second coil 12b are disposed separately from each other. However, as shown in FIG. 7 and FIG. 8, the paired coils 12 may be adjacent to and contact each other. In addition, although the high-permeability core material 3 and the low-permeability core material 4 are provided in the above-described embodiment, two types of the core materials may not be necessarily filled, but one type of the core material may be filled. In an example shown in FIG. 7 and FIG. 8, the outer peripheries of the adjacent paired coils 12 (the first coil 12a and the second coil 12b) in the radial direction contact each other, and the low-permeability core material 4 is filled in the entire case 10. In the adjacent portions of the first coil 12a and the second coil 12b, the flat surfaces of the outermost peripheries of the rectangular wires 13 are tightly fitted. In this configuration, the first coil 12a and the second coil 12b are insulated by enamel that coats each of the coils 12a, b. Furthermore, instead of the configuration in which the high-permeability core material covers the adjacent portions of the paired coils 12 as in the above embodiment, the low-permeability core material 4 covers the entire paired coils 12. Thus, the adjacent portions of the first coil 12a and the second coil 12b are covered by the low-permeability core material 4.

According to such a configuration, because the adjacent portions of the paired coils 12 contact each other, the coils 12 can be disposed in a tightly fitted manner in the case 10. This allows downsizing of the case 10. Accordingly, it is possible to downsize the reactor 2. More specifically, if the magnetic flux direction of the paired coils 12 (the first coil 12a and the second coil 12b) is the same, it is necessary to secure a space for the magnetic flux that is generated in each of the coils 12a, b to flow through, and it is also necessary to separate the paired coils 12a, b to avoid contact with each other. However, according to the technique disclosed herein, the magnetic flux directions of the paired coils 12a, b oppose each other, and the magnetic flux generated in each of the coils 12a, b is joined to each other. Accordingly, there is no need to secure the space for the each magnetic flux to flow through. Therefore, it is possible by contacting the paired coils 12a, b to downsize the reactor 2.

In the example shown in FIG. 7 and FIG. 8, the low-permeability core material 4 is filled in the case 10. However, the configuration is not limited thereto. Instead of the low-permeability core material 4, the high-permeability core material 3 may be filled in the case 10. In addition, a magnitude of the permeability of the core material that is filled in the case 10 is not particularly limited. Furthermore, as in the example of FIG. 1 to FIG. 3 described above, both of the high-permeability core material 3 and the low-permeability core material 4 may be filled in the case 10. That is, as described above, the high-permeability core material 3 may cover the adjacent portions of the paired coils 12 while the low-permeability core material 4 may cover the portions of the coils 12 that are exposed from the high-permeability core material 3.

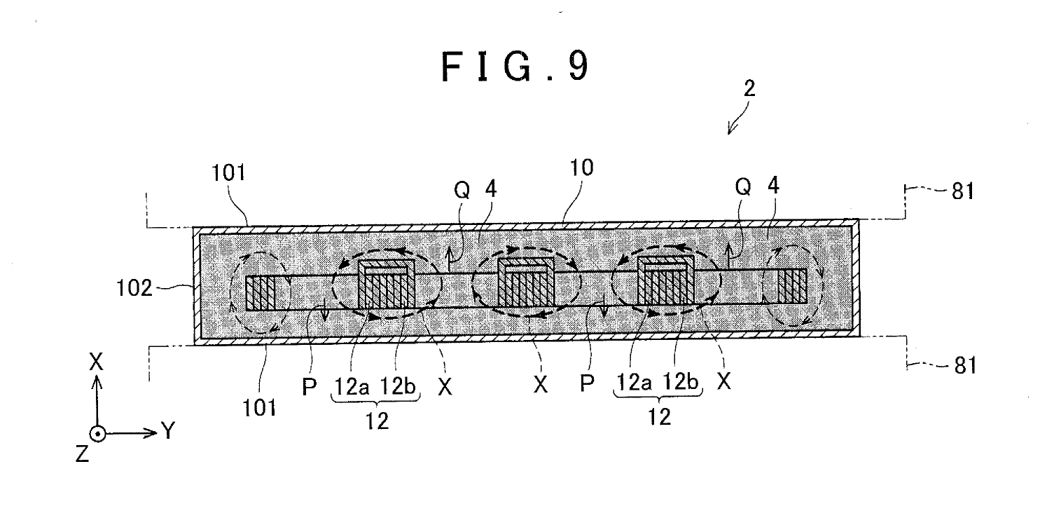

In the above-described embodiment, the two coils 12 are used. However, as shown in FIG. 9, the four coils 12 may be used. Also in this embodiment, the winding directions of the adjacent coils 12 oppose each other. In addition, the number of the coil 12 is not particularly limited and thus can be increased.

In the reactor 2, in order to increase the heat transfer efficiency from the coil 12 to the cooler 81, the depth D of the case 10 is preferably set as minimum as possible to increase a rate of flatness. Thus, a distance between the end of the coil 12 and the cooler 81 is preferably short when seen in the stacked direction. When the distance between the end of the coil 12 and the cooler 81 is reduced, a thickness on an outer side of the high-permeability core material 3 from the end of the coil 12 in the axial direction is reduced. This thickness portion of the high-permeability core material 3 constitutes a part of the magnetic path that is formed annularly between the paired coils 12. However, the reduction in thickness indicates that the magnetic path is narrowed. If the magnetic path is narrowed, an area through which a magnetic line passes is reduced, and the magnetic saturation is thereby likely to occur. Furthermore, in general, the magnetic saturation is more likely to occur with the higher permeability. Thus, when the case 10 is configured to be flat and the high-permeability core material 3 is adopted, the magnetic saturation is likely to occur. If the magnetic saturation occurs, the magnetic flux that flows through the outside of the core material (the so-called leaked magnetic flux) is increased. Meanwhile, the coolers 81 are placed on both sides of the case 10 in the reactor 2, and the coolers 81 tend to be made of a metal. If the magnetic flux that is leaked from the high-permeability core material 3 passes through the metallic cooler 81 in the flat case 10, the eddy current is generated. In consideration of this, the high-permeability core material 3 is surrounded by the low-permeability core material 4. As illustrated in FIG. 4, generally, the magnetic saturation is less likely to occur with the lower permeability. By surrounding the high-permeability core material 3 with the low-permeability core material 4, the magnetic flux that is leaked from the high-permeability core material 3 is absorbed by the low-permeability core material 4, and the magnetic flux that passes through the cooler 81 is thereby reduced.

The practical examples of the present invention have been described so far in detail. However, they are merely examples and thus do not limit the scope of the claims. The technique described within the scope of the claims includes various modifications and changes that are made to the above-illustrated practical examples. The technical elements that are described in this specification and the drawings demonstrate technical utility when used singly or in various combinations, and thus are not limited to the combinations described in the claims in the original application. The techniques that are illustrated in this specification and the drawings achieve a plurality of objects simultaneously, and the achievement of one object thereof itself has technical usefulness.

What is claimed is:

1. A reactor that can be disposed between stacked coolers, the reactor comprising:
a flat case;
a pair of coils: (i) located in the flat case, (ii) wound in opposite directions from each other, and (iii) disposed adjacent to each other in a radial direction of the coils; and
a core material covering the coils in the flat case.

2. The reactor according to claim 1, wherein
the coils of the pair of coils are aligned in a direction intersecting an axial direction of winding of the coils.

3. The reactor according to claim 1, wherein
the core material includes a high-permeability core material and a low-permeability core material, the high-permeability core material covers first portions of each of the pair of coils, and the low-permeability core material covers the high-permeability core material and covers second portions of each of the pair of coils not covered by the high-permeability core material.

4. The reactor according to claim 3, wherein
the pair of coils includes a first coil and a second coil, and
the first portions of the first and second coils face each other and are covered by the high-permeability core material, and the second portions of the first and second coils do not face each other and are not covered by the high-permeability core material.

5. The reactor according to claim 1, wherein
outer peripheries of the coils of the pair of coils in the radial direction contact each other.
